(19) United States
(12) Patent Application Publication
(10) Pub. No.: US 2016/0332202 A1
(43) Pub. Date: Nov. 17, 2016

(54) INTERCHANGEABLE BASKET TREATMENT SYSTEM

(71) Applicant: CO2Nexus, Inc., Littleton, CO (US)

(72) Inventors: Chris Robbins, Littleton, CO (US); Stephen Whitney Madsen, Arvada, CO (US)

(73) Assignee: CO2Nexus, Inc., Littleton, CO (US)

(21) Appl. No.: 15/154,055

(22) Filed: May 13, 2016

Related U.S. Application Data
(60) Provisional application No. 62/162,408, filed on May 15, 2015.

(51) Int. Cl. B08B 3/04

(52) U.S. Cl. CPC B08B 3/041

(57) ABSTRACT

An interchangeable basket treatment system receives a removable agitation basket preloaded with articles through a first door. Once positioned within the chamber and the chamber is sealed, the basket is, in one embodiment, suspended so that it may be manipulated to produce mechanical interaction between the articles and treatment fluids within the chamber. Upon completion of the treatment cycle the chamber is accessed via a second door and the basket and its contents removed.

### RELATED APPLICATION

The present application relates to and claims the benefit of priority to U.S. Provisional Patent Application No. 62/162,408 filed 15 May 2015 which is hereby incorporated by reference in its entirety for all purposes as if fully set forth herein.

### BACKGROUND OF THE INVENTION

1. Field of the Invention

Embodiments of the present invention relate, in general, to fluidic treatment systems and more particularly to treatment systems having a removable and interchangeable interior basket.

2. Relevant Background

The cleaning or treatment of articles of clothing or similar textiles has traditionally occurred in a washing machine or device that is comprised of a cabinet housing a drum within which is a basket. The articles are placed within the basket which is contained within the cabinet and a washing or treatment cycle is initiated. A single door accesses the basket either on the top in a top-loading machine or from the front in a front-loading machine. As fluid is introduced to the drum the basket engages various mechanisms to create a mechanical interaction between the articles, fluid and basket to create a treatment action.

Articles other than clothes or textiles that require cleaning or fluidic treatments are often run through a fluidic environment on a continuous drive belt or secured within a room (cabinet) in which fluids are thereafter applied. For example, automobile parts run thought a spray barn or are immersed in fluid while on an assembly line. Similarly, electronic components are subjected to various fluidic treatments after being secured within a treatment environment. Vapor deposition is an example of this process.

In the case of a cleaning or treatment chamber, the cabinet, drum and basket are typically assembled prior to delivery and, except for maintenance and repair, form a single device. In a conventional washing machine, articles to be cleaned are added to the basket prior to the washing cycle and removed from the basket after the completion of the washing process. As clean articles are removed and replaced with soiled items, the machine is idle. Moreover, the loading and unloading of the machine is largely a human intensive operation and cannot easily be automated. Accordingly, significant time is spent moving articles to and from the washer, and in some cases to and from a dryer.

While industrial treatment facilities such those in an automotive assembly plant move components through a fluidic environment efficiently, they are generally immobile within the environment and rely on the simple exposure to the fluid to enable the desired treatment to occur. Such a system works well for the application of paint, for example, but not so well when some sort of mechanical interaction is desired to achieve the desired affect. What is needed, therefore, is system by which articles/components can be quickly and efficiently introduced and removed to a treatment environment of any one of a plurality of treatment machines and yet when installed within the treatment machine, be engaged to provide mechanical interaction between the treatment fluid and the articles within the basket.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

An interchangeable basket treatment system and associated methodology is hereafter disclosed by way of example. According to one embodiment of the present invention a treatment chamber receives a basket preloaded with articles. The chamber includes, in one embodiment, a drum that is configured to receive and secure the basket. Once secured within the drum or wash chamber the basket may engage in various motions by which to create mechanical interaction between a treating fluid, the basket itself and the articles within.

Once the treatment cycle is complete, the chamber is again accessed and the basket, including the articles contained within are removed making availability in the chamber for another, preloaded basket. In another embodiment of the present invention the basket, having been removed from the chamber can be placed in a drying cabinet. Once the articles are dry the basket can once again be removed and replaced with another basket. With the articles clean and dry the basket is opened and the articles removed for further processing.

According to one embodiment of the present invention a removable basket treatment system includes a treatment chamber having first sealable opening and a second sealable opening including a longitudinal axis extending from the first sealable opening to the second sealable opening. The system is further comprised of a removable agitation basket dimensioned to pass through the first sealable and through the second sealable opening, and a drive mechanism wherein the drive mechanism rotates the removable agitation basket about the longitudinal axis within the treatment chamber.

Additional features of the invention include that articles are placed inside the removable agitation basket prior to the removable agitation basket being placed inside the treatment chamber. Additionally, the treatment chamber can be substantially cylindrical and in some cases a pressurized vessel. In the instances in which the treatment chamber is a pressurized vessel it can be configured to hold a densified fluid. The removable agitation basket of the present invention is configured to create a mechanical interaction between a washing fluid and a treatment article apart from the treatment chamber.

In other embodiments the drive mechanism rotates the removable agitation basket within the treatment chamber about the longitudinal axis. The removable basket treatment system of the present invention can further include a translation rail within the treatment chamber for guiding the removable agitation basket through the sealable first opening and through the sealable second opening. The invention further contemplates and discloses one or more methodologies consistent with the system described above.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high level perspective view of a removable agitation basket and a representative treatment chamber, according to one embodiment of the present invention;

FIG. 2 is a front elevated perspective view of a treatment chamber having first and second sealable openings with a removable agitation basket within its interior in accordance with one embodiment of the present invention;

FIG. 3 is a side view of one embodiment of an interchangeable agitation basket treatment system;

FIG. 4 is a perspective view of a translation bed suitable for assisting in the loading and removal of a removable agitation basket with the interchangeable agitation basket treatment system of the present invention;

FIGS. 5A, B and C are side views of a treatment chamber according to one embodiment of the present invention showing three sequential positions of a removable agitation basket as it is inserted into the treatment chamber and thereafter suspended to provide mechanical interaction between articles contained within the basket and fluid within the chamber;

FIGS. 6A and 6B are end views of another embodiment of the present invention for suspending and providing mechanical interaction between articles contained inside a removable basket and fluid within a treatment chamber; and

FIG. 7 is a flowchart of one method embodiment for treatment of articles using the interchangeable basket treatment system of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

An interchangeable basket treatment system treats articles in a fluidic environment by placing articles inside a basket while apart from a treatment chamber, inserting the filled basket into the chamber, and responsive to the completion of a treatment cycle, removing the basket and the articles contained within. The invention enables multiple baskets of articles to be prepare separately for treatment so that upon the completion of a prior treatment cycle, the prior basket can be removed and replaced with a new basket of articles to be thereafter treated. In such a manner the treatment chamber is more efficiently utilized with minimal downtime between cycles.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

One should note that for purposes of the present invention the term articles should be considered to be inclusive and not exclusive. For example, soiled articles can include textiles, garments, hardware, substrates, or other material by which treatment can be accomplished using a fluid. Moreover, for the purposes of the present application the term fluid is used to describe a gaseous, liquid and/or supercritical state of any substance or any combination thereof.

Likewise, the terms “basket” should be viewed and interpreted broadly as a component or similar device that is used to contain or isolate articles within the treatment chamber. And while the basket shown thing is predominantly cylindrical other embodiments or implementations may adopt a different shape without aversely impacting the spirit or scope of the present invention.

One or more embodiments o the present invention may utilize a supercritical or densified fluid. Typically, a substance can be thought of to exist in three distinct phases. These phases or states are commonly known as solid, liquid, or gas. A phase diagram is a graphical representation of the physical states of a substance under different conditions of temperature and pressure. A typical phase diagram has pressure on the Y axis and temperature on the X axis. As one moves across the lines or curves on the graph a substance's phase changes from one to the next. Moreover, the two adjacent phases of a substance can coexist or are in equilibrium on the line separating these regions. The critical point on the graph is a point in the phase diagram in which temperature and pressure are such that the liquid and gaseous phases of the substance are indistinguishable. Beyond this point the temperature and pressure are such that a merged single phase known as is a supercritical fluid exists. The distinction between fluid and gas ceases to exist beyond this point and the substance is referred to as a supercritical fluid.

Supercritical fluids can diffuse through solids like a gas, and dissolved materials like a liquid. In addition, close to the critical point, small changes in pressure or temperature result in large changes in density, allowing many properties of a supercritical fluid to be “fine-tuned”. Supercritical fluids are often used as a substitute for organic solvents in a range of industrial laboratory processes. In general, supercritical fluids have properties of both a gas and liquid; supercritical fluids (and for that matter densified fluids) can include carbon dioxide, water, methane, ethane, propane, propylene, ethanol, acetone, and ethylene. One significant characteristic of supercritical fluids is that there is no surface tension between the liquid/gas phase boundary. By changing the pressure and temperature of the fluid, the properties can be “tuned” to be more liquid or more gas like.

The advantages of supercritical fluid extraction (compared with liquid extraction) is that extraction from the textile is relatively rapid because of the low viscosity and high diffusivities. Extraction can be selective to some extent by controlling the density of the medium. Moreover, the extracted material is easily recovered by simply depressurizing supercritical fluid and allowing the supercritical fluid to return to a gas phase. The evaporation process leaves little solid residue behind.

Changes in pressure and temperature can also change the density of a substance such as liquid carbon dioxide. Increasing the pressure always increases the density of a material while increasing the temperature generally decreases the density with some notable exceptions. For example, the density of water increases between its melting point at 0° C. and 4° C. As is commonly know the density of water is greater than that of ice.

The effect of pressure and temperature on the densities of liquids and solids is small. The compressibility for a typical liquid or solid is 10−6 bar−1 (1 bar=0.1 MPa) and a typical thermal expansivity is 10−5 K−1. This roughly translates into needing around ten thousand times more atmospheric pressure to reduce the volume of a substance by one percent. A one percent expansion of volume typically requires a temperature increase on the order of thousands of degrees Celsius. So while the change in density of a liquid is substantially insignificant, the point at which it transitions from a liquid to a gas can be significantly impacted by both pressure and temperature. Therefore, a densified fluid (gaseous, liquid or supercritical) comprises, for the purposes of this application, a substance or solution that, based on temperature or pressure, varies between gaseous, liquid or a supercritical state. One of reasonable skill in the art will recognize that a densified fluid will, in its liquid state, be coexistent with a gaseous form of the fluid in areas having a free surface such as, for example, the treatment chamber.

Included in the description are flowcharts depicting examples of the methodology which may be used to use an interchangeable basket treatment system. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Upon reading this disclosure, those of skill in the art will appreciate still additional alternative structural and functional designs for a system and a process for treating articles using an interchangeable basket system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

In one embodiment of the present invention a treatment chamber can comprise a dual door configuration. In such a configuration the treatment environment is largely cylindrical or rectangular with the longitude axis of the cylinder/rectangle parallel with the floor. The chamber thus includes a first and second sealable access door located on opposite ends of the chamber. An interchangeable or removable basket is preloaded with soiled articles and lifted into position proximate to one of the two access doors. With the basket aligned with the treatment chamber, one of the doors is opened and the basket loaded into the treatment chamber. Once inside the chamber the basket is suspended within the chamber and within a fluid medium to treat the articles. In one embodiment of the present invention the basket is configured to engage a drive mechanism within the chamber to create mechanical interaction between the articles, the basket and the fluid to enhance the treatment process.

Upon completion of the treatment process the second sealable access door is opened and the basket, containing treated articles, is removed. At substantially the same time, another basket, preloaded with soiled articles, can be loaded into the chamber from the first door thus minimizing the time the chamber is idle.

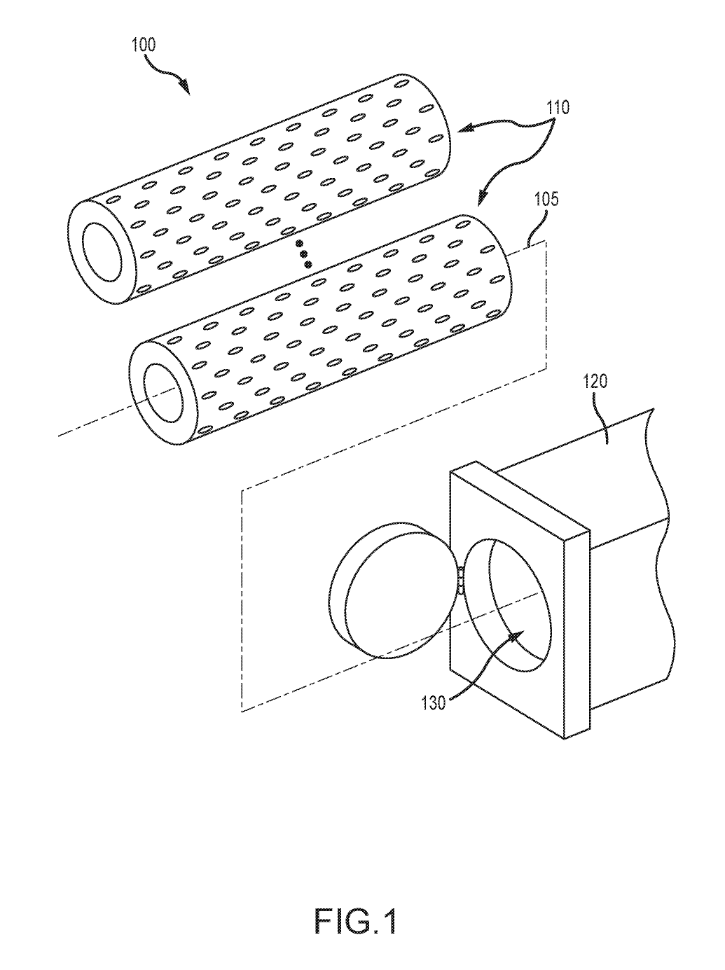

FIG. 1 shows a high level perspective view of an interchangeable/removable agitation basket and a representative treatment chamber, according to one embodiment of the present invention. The removable agitation basket 110 is, as shown, a separate component from the treatment chamber 120. According to one embodiment of the present invention, the removable agitation basket is a substantially hollow structure that can accept one or more articles for treatment. Once articles have been placed within a removable agitation basket, the basket and the articles contained within, can be positioned through a first sealable opening 130 within the treatment chamber. For the purposes of the present invention the term “removable” and “interchangeable” will be considered synonymous.

The removable agitation basket can, in other embodiments, be segmented to enable different types of articles to be processed within the same treatment cycle. The basket can be constructed from a variety of material including stainless steel, composites, polymers, plastics and the like. The preloaded nature of the basket and the flow through design also enable the treatment process to be entirely automated or operated with significantly reduced oversight.

Once placed within the treatment chamber, the removable agitation basket is suspended and engaged by a drive mechanism. The drive mechanism can thereafter manipulate the removable agitation basket within the chamber to enhance the treatment process. With the chamber sealed, a treatment fluid is introduced and drive mechanism creates a mechanical interaction between the articles contained within the basket and the fluid.

Upon completion of the treatment process a second sealable door is opened and the basket (and articles) removed. With the chamber empty a new, previously provisioned, removable agitation basket can be placed into the chamber for treatment.

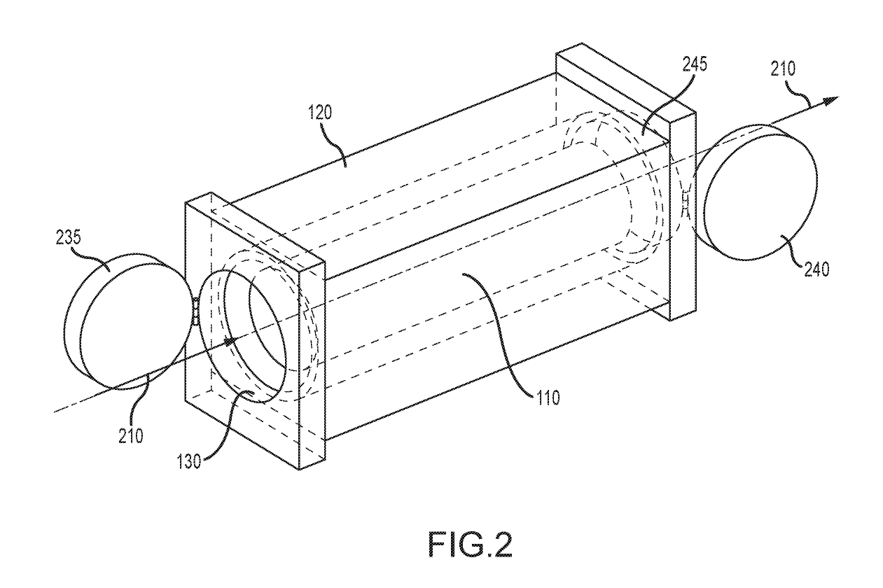

FIG. 2 presents a front elevated perspective view of a treatment chamber having first and second sealable openings with a removable agitation basket within its interior in accordance with one embodiment of the present invention. In this rendering one of reasonable skill in the relevant art can appreciate that the treatment chamber 120 possesses a flow-through design. A removable agitation basket 110 can enter the chamber 120 through the first sealable opening 130 and exist the chamber 120 through the second sealable opening 245. The closing of a first door 235 and a second door 240 isolates the treatment chamber 120 so that a treatment fluid can be added.

The embodiment shown in FIG. 2 presents a substantially rectangular treatment chamber and a cylindrical removable basket and circular doors. One or reasonable skill in the relevant art will appreciate that these shapes are illustrative and not limiting. Indeed, other shapes for the chamber, basket and access doors are possible and indeed contemplated without departing for the spirit and scope of the present invention. These implementation methodologies are known within the art and the specifics of their application within the context of the present invention will be readily apparent to one of ordinary skill in the relevant art in light of this specification.

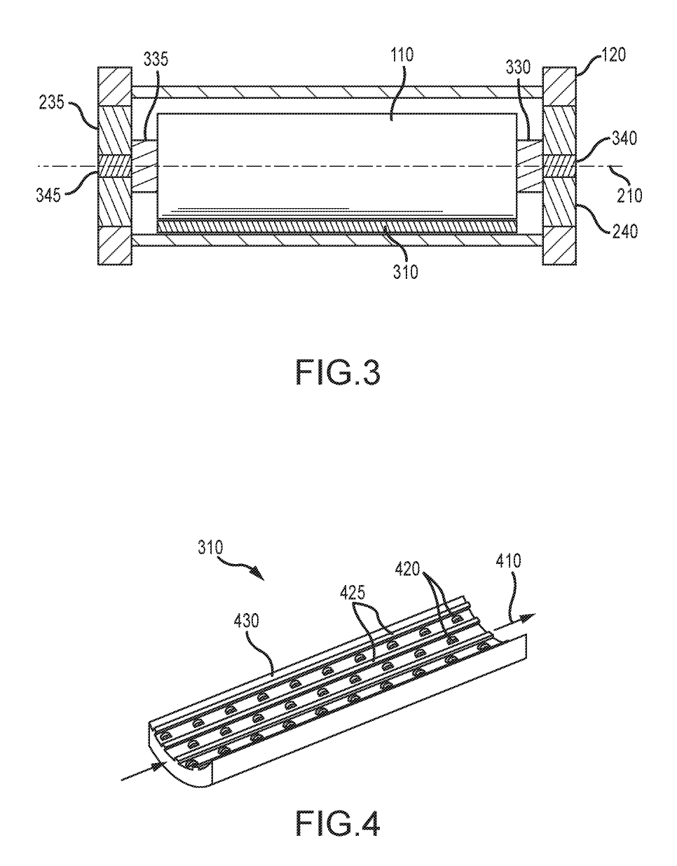

FIG. 3 is a side view of one embodiment of an interchangeable agitation basket treatment system. As shown the basket 110 is suspended within the chamber 120 and free to rotate about its longitudinal axis 210. In this embodiment of the present invention a drive mechanism 330, 335 is positioned at either end of the basket to both suspend and rotate the removable agitation basket 110. The drive mechanism(s) 330, 335 includes a shaft 340, 345 that traverses one or both doors 235, 240 and provides the ability for additional components to be positioned outside of the fluidic environment inside the treatment chamber 120.

This side view of the treatment chamber also shows a translation bed 310 or guide located at the lower portion of the chamber. For insertion and removal of the basket the guide supports the basket and maintains the basket's lateral alignment.

FIG. 4 is a perspective view of a translation bed 310 suitable for assisting in the loading and removal of a removable agitation basket with the interchangeable agitation basket treatment system of the present invention. The guide or bed 310, in one embodiment, includes an upper concave surface 430 corresponding with the outer shape and dimensions of the removable agitation basket 110. The bed 310 is of sufficient depth that it aligns with or is slightly above the lower edge of the first and second sealable opening. As the first and second sealable openings are sized to be larger than the outer radius or dimension of the removable basket, the basket is able to pass through the openings and rest on the translation bed.

Rollers 420 or rails 425 on which the agitation basket can be maneuvered through the treatment chamber are embedded within the translation bed 310. In other embodiments, metal or Teflon coated rails may be present to enable the removable basket to simply slide through the chamber. Once the removable agitation basket is fully within the chamber, the guide positions the removable agitation basket so that it may be suspended and engaged by the driving mechanism. In other embodiments of the present invention the translation bed can also server as a heat sink to aid in temperature control within the treatment chamber.

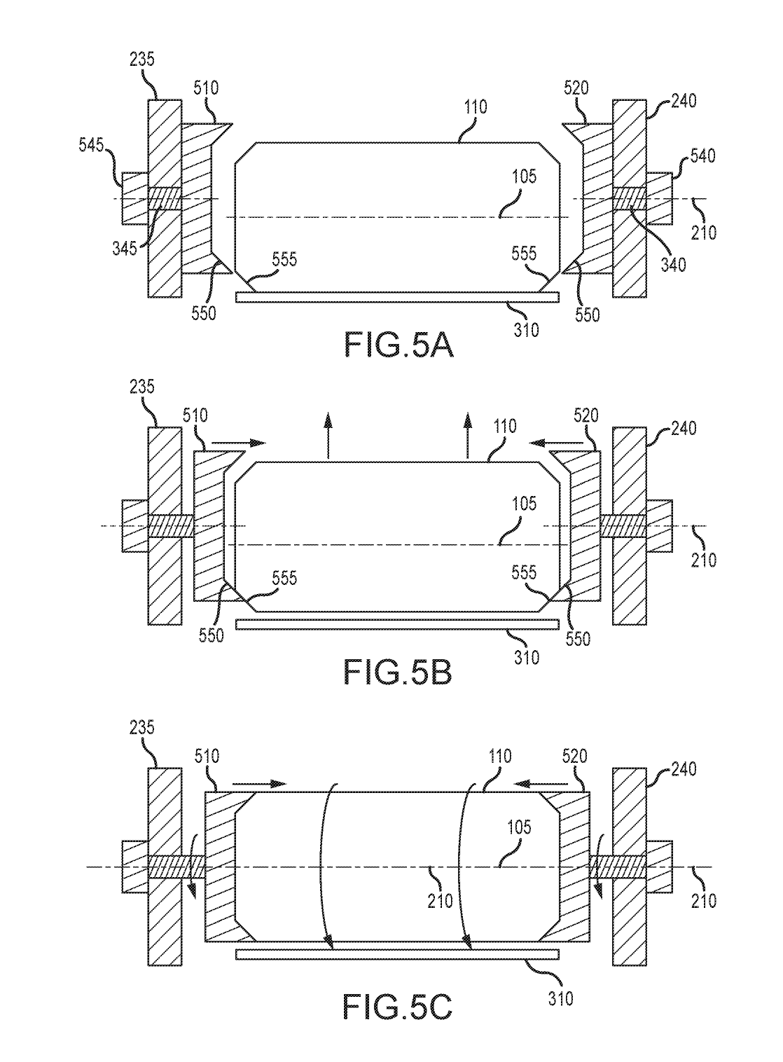

FIGS. 5A, B and C are side views of a treatment chamber according to one embodiment of the present invention showing three sequential positions of a removable agitation basket as it is inserted into the treatment chamber and thereafter suspended to provide mechanical interaction between articles contained within the basket and fluid within the chamber. FIG. 5A shows the position of the removable agitation basket after it has been inserted through the first sealable opening into the treatment chamber and is resting on the translation guide.

In one embodiment of the present invention the first and second doors which close and seal the first and second sealable openings include a drive and basket suspension mechanism. To facilitate mobility of the basket within the chamber, a support structure is provided to enable the basket 110 to move freely while maintaining easy access to articles contained within a basket when the basket is outside of the treatment chamber. According to one embodiment of the present invention the basket 110 is supported by a pair of rotatable actuators 510, 520, one coupled to each door 235, 240 on the end of the treatment chamber 120. As each actuator 510, 520 engages the basket 110, an axis 105 on which the basket can rotate is aligned with a fixed longitudinal 210 axis of the actuator. An actuator shaft 340, 345 further traverses, in one embodiment, each sealable door and includes a bearing assembly to enable the basket/actuator combination to rotate freely within the treatment chamber. In one embodiment of the present invention a drive system 540, 545 engages the actuator and thus the basket to provide for the necessary interaction between the articles within the basket and the treatment fluid. In one embodiment, the actuator and sealable door are integrated components and act as a single unit while in other embodiments the actuator and sealable door are separate and operate independently.

Returning to FIG. 5A and as mentioned above, the rotatable support actuator 510, 520 includes an actuator plate having, in one embodiment, a set of actuator ramps 550 that, when interfaced with complementary ramps 555 associated with the basket, align the basket's central axis 105 with the longitudinal axis 210 of the drive system 540, 545. At rest and with the door(s) open the actuator is withdrawn from contact with the basket. By doing so the basket rests on a translation bed 310 slightly out of alignment with the longitudinal axis 210. In a preferred embodiment of the present invention the actuator plates 510, 520 are retracted from engagement with the basket 110 prior to the opening of either sealable door 235, 240. Upon closing of both doors the actuator 510, 520 extend the respective actuator ramps 550 to engage with the basket ramps 555 to raise the basket's central axis into alignment with the shaft fixed axis. FIG. 5A presents the basket resting on the translation bed 310 prior to engagement by the actuator ramps 550. FIG. 5B presents a mid state in which the actuator ramps 550 have engaged and are in contact with the basket ramps 555 but the central axis 105 of the basket 110 is not yet aligned with the longitudinal axis 210 of the treatment chamber. With both doors closed and with the actuators extended so as to engage the basket, the basket's only contact with the treatment chamber is via the actuators and thus the basket has risen off the translation bed.

The engagement actuators 510, 520 presented in this example can take a number of forms while still accomplishing the desired objective of aligning the central axis of the basket with the axis of the rotatable shaft. According to one embodiment of the present invention the actuator comprises a set of spokes positioned equidistantly about the actuator wherein each spoke includes an actuator ramp 550 for engaging a complementary basket ramp 555. Correspondingly, the entire edge of the basket includes the basket ramp 555 configuration forming a cone such that regardless of the location of the interface between the actuator ramp 550 spokes and the basket ramp 555 the basket will be secured by actuator and positioned so as to align the basket central axis 105 with the longitudinal axis 210 of the shaft. In another embodiment the entire actuator plate 510, 520 includes or is comprised of a ring of actuator ramps 550. As the actuator plate 510, 520 and actuator ramp 550 extend so as to make contact with the basket ramp 555, the engagement of the inclined ramps acts to lift and center the basket 110 about the longitudinal axis 210 using a coning effect. One skilled in the art will also recognize that the orientation and degree of slope of the ramps may vary without diminishing the scope of the present invention or the ability of the actuator to lift the basket into alignment.

In a preferred embodiment the angle of interaction between the respective ramps 550, 555 is between 10 and 30 degrees with a preferred angle of 22 degrees. If an angle of less than 10 degrees is used excessive travel is required to lift the basket into alignment. Moreover, shallow ramps in a coning interaction can lock preventing the basket from releasing once the proper point of alignment is achieved. Alternatively, the use of an angle larger than 30 degrees provides a poor mechanical advantage for lifting the basket. And while the present invention uses linear matching ramps, the angular dimensions of each ramp could vary so as to produce complementary curvilinear ramps.

FIG. 5C presents a side view of the removable agitation basket 110 fully engaged and suspended by the actuators 510, 520. With the central axis 105 of the removable agitation basket aligned with the longitudinal axis 210 of the treatment chamber 120 the actuators 510, 520 in conjunction with the drive mechanism 540, 545 can spin the basket within the treatment chamber to provide mechanical interaction between the articles contained within the removable agitation basket and the treatment fluid.

While the previous example describes a sealable door through which an actuator translates so as to engage and center the basket, another contemplated design of the present invention is to combine the centering functionality of the actuator plate and ramps with the door itself. In such an embodiment closing of the sealable door acts to position and drive the actuator ramps so as to lift and center the basket. With the door closed and basket centered the actuator shaft, plate and basket rotate as previously described.

Another feature of the present invention is a drive mechanism to drive the movement of the basket within the treatment chamber. Once the basket is centered a drive mechanism, described below, rotates, in one embodiment, the actuator which in-turn rotates the basket about a fixed axis. The torque to rotate the basket is delivered from the actuator system to the basket in one embodiment, via friction. As one of reasonable skill can appreciate the torque necessary to rotate, agitate, and spin a large basket containing substantial can be significant. While there is a frictional interaction between the ramps of the actuator system and the basket, the normal force necessary to convey adequate friction to meet the torque requirement can be significant and substantially larger than the force necessary to lift the basket into alignment. According to one embodiment of the present invention a set of spring loaded tabs associated with the actuator ramps interlock with one of a plurality of channels in the basket ramp/cone. As the actuator ramps engage the basket ramp cone sufficient force is applied to lift the basket into alignment but not enough force to prevent the basket from rotationally slipping. As the actuator rotates and its associated torque is transferred to the basket, the interface between the actuator ramp and basket cone slips until the actuator tab is aligned with one of the plurality of basket channels. Upon alignment the tab extends into the channel forming a positive lateral engagement by which the transfer of torque is efficiently conveyed. Thereafter no slippage between the actuator and the basket occurs.

The basket, once positioned within the chamber and in a movable configuration is driven so as to manipulate the articles within the basket to create interaction with the treatment fluid solution using gravity. According to one embodiment the basket is driven by the one or more actuator shafts/plates that engage the basket. As described in the previous example one configuration includes a shaft extending from the exterior of each sealable door to interact with and rotate the basket. Once the actuator engages the basket and positions it so as to align with the fixed axis of the shaft, the shaft and actuator combination are used to drive the basket. According to another embodiment of the present invention a drive mechanism is positioned on the outside of the chamber and associated with one door to engage and rotate the shaft after the actuator has aligned the basket. By doing so the drive mechanism remains outside of chamber and is not subjected to the austere conditions of the treatment environment. In other embodiments both actuator shafts are used to drive the basket. In yet another embodiment a drive mechanism drives the actuator plate rather than the shaft.

Another version of the drive mechanism can be a belt system while in another version the mechanism can be a mechanical or geared linkage. One of reasonable skill in the relevant art will recognize that there are a variety of means by which the basket within the chamber can be drives so as to create mechanical interaction between the articles and the fluid.

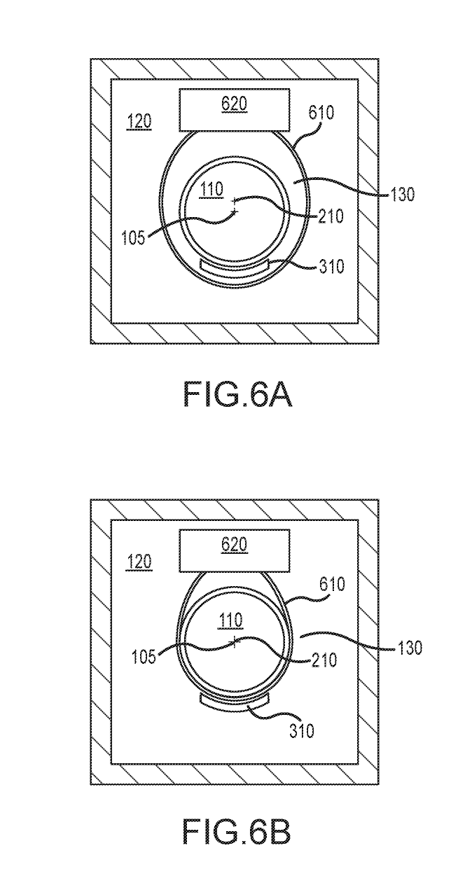

FIG. 6A and 6B are end views of another embodiment of the present invention for suspending and providing mechanical interaction between articles contained inside a removable basket and fluid within a treatment chamber. The end views of the treatment chamber 120 shown in FIGS. 6A and 6B illustrate the removable agitation basket 110 in an end on view. In FIG. 6A the removable agitation basket 110 rests on the translation bed 310 with basket centerline 105 below the longitudinal axis 210 of the treatment chamber.

A drive belt 610 or similar friction mean by which to engage the circumference of the basket loops around and below the removable agitation basket 110. The belt is coupled through a drive mechanism 620 located, in this embodiment of the present invention, in the upper portions of the treatment chamber 120.

FIG. 6B presents another end view of the treatment chamber 120 but with the belt 610 tightened to suspend the removable agitation basket 110 off of the translation bed 310. In this depiction the axis 105 of the removable agitation basket 110 and the longitudinal axis 210 of the chamber 120 are aligned. Unlike the prior embodiment, this type of drive mechanism would not require that the two axis be aligned to be functional. With the basket 110 suspended by the belt(s) the drive mechanism 620 can rotate the removable agitation basket to create mechanical interaction between the articles contained within and the treatment fluid. While the illustration shows a single belt one of reasonable skill in the relevant art will recognize that two or more belts would be required to raise and suspend the basket so as to be apart from the translation bed. In other embodiments a drive mechanism can be incorporated into the translation bed itself so that upon the positioning of the basket on the bed within the chamber the basket is mechanically engaged via the bed for later manipulation.

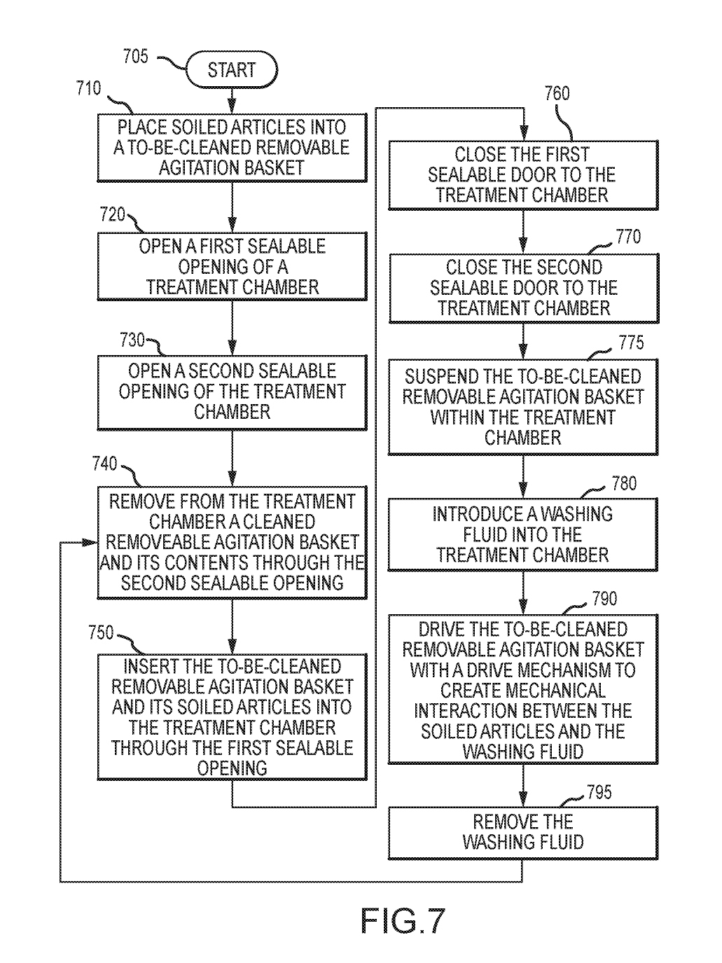

FIG. 7 is a flowchart of one method embodiment for using the interchangeable basket treatment system of the present invention. The process begins 705 by placing 710 soiled articles such as textiles or clothing within a second removable agitation basket while the second removable agitation basket is apart from the treatment chamber. Once the articles to be treated have been placed within the basket the treatment chamber is accessed by opening the first sealable opening 720 and opening the second sealable opening 730.

With the treatment chamber open at both ends a first removable agitation basket that currently resides within the treatment chamber is removed 740 through the second opening. With the removal of the first agitation basket the chamber is receptive of the second agitation basket 750. The second removable agitation basket is inserted into the chamber through the first opening. While these steps are distinct one skilled in the relevant art will appreciate that the removal of the first agitation basket and its replacement with the second basket can occur substantially concurrently.

With the second removable agitation basket fully within the treatment chamber the process continues with the closing 760 of the first sealable door and the closing 770 of the second sealable door. The removable agitation basket is, in one embodiment, suspended 775 within the treatment chamber and a treatment fluid is introduced 780 into the environment.

A drive mechanism thereafter drives 790 the basket within the treatment chamber to create a mechanical interaction between the articles contained within and the treatment fluid. Upon completion of the cycle, the fluid is drained 795 enabling the process to begin anew 705.

The embodiments of the present invention offer a system by which an interchangeable agitation basket can be provisioned apart from a treatment chamber and, once the chamber becomes available, quickly positioned within the chamber for treatment. The flow-through design of the present invention minimizes idle/non-operational time during which the treatment chamber is non-functional. By quickly and efficiently removing a prior treated basket that is full of treated articles and replacing it with a basket of yet untreated or soiled articles, the down time of the chamber is minimized.

The invention includes a chamber having two access points on opposite sides of the chamber. The doors are aligned to enable a removable basket to enter one door while a second basket is removed from the other door. Once in place the basket is suspended and attached to a drive mechanism to provide mechanical interaction between treatment fluid located within the chamber and the articles themselves.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

While there have been described above the principles of the present invention in conjunction with an interchangeable basket treatment system, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A removable basket treatment system, comprising:
a treatment chamber having first sealable opening and a second sealable opening including a longitudinal axis extending from the first sealable opening to the second sealable opening;
a removable agitation basket dimensioned to pass through the first sealable and through the second sealable opening; and
a drive mechanism wherein the drive mechanism rotates the removable agitation basket about the longitudinal axis within the treatment chamber.

2. The removable basket treatment system of claim 1, wherein the treatment chamber is substantially cylindrical.

3. The removable basket treatment system of claim 1, wherein the treatment chamber is a pressurized vessel.

4. The removable basket treatment system of claim 3, wherein the pressurized vessel is configured to hold a densified fluid.

5. The removable basket treatment system of claim 1, wherein the removable agitation basket is substantially cylindrical.

6. The removable basket treatment system of claim 1, wherein the removable agitation basket is configured to create a mechanical interaction between a washing fluid and a treatment article apart from the treatment chamber.

7. The removable basket treatment system of claim 6, wherein the treatment fluid is a densified fluid.

8. The removable basket treatment system of claim 1, further comprising an article placed inside the removable agitation basket prior to the removable agitation basket being placed inside the treatment chamber.

9. The removable basket treatment system of claim 1, wherein the drive mechanism moveably suspends the removable agitation basket between the first sealable opening and the second sealable opening.

10. The removable basket treatment system of claim 1, wherein the drive mechanism rotates the removable agitation basket within the treatment chamber about the longitudinal axis.

11. The removable basket treatment system of claim 1, further comprising a translation rail within the treatment chamber for guiding the removable agitation basket through the sealable first opening and through the sealable second opening.

12. The removable basket treatment system of claim 1, wherein the longitudinal axis passes through the first sealable opening and the second sealable opening.

13. The removable basket treatment system of claim 12, wherein the first sealable opening is on a first end of the treatment chamber and the second sealable opening is on a second end of the treatment chamber.

14. A method for exchanging removable agitation baskets in a treatment system, the method comprising:
opening a first sealable opening of a treatment chamber;
opening a second sealable opening of the treatment chamber wherein a line extending from the first sealable opening to the second sealable opening defines a longitudinal axis;
removing a first removable agitation basket from the treatment chamber though the second sealable opening; and
inserting a second removable agitation basket into the treatment chamber through the first sealable opening.

15. The method for exchanging removable agitation baskets in a treatment system of claim 14, further comprising inserting into the second removable agitation basket a soiled article for treatment.

16. The method for exchanging removable agitation baskets in a treatment system of claim 15, further comprising closing the first sealable opening and closing the second sealable opening.

17. The method for exchanging removable agitation baskets in a treatment system of claim 15, further comprising treating the soiled article with a washing fluid.

18. The method for exchanging removable agitation baskets in a treatment system of claim 17, further comprising driving the removable agitation basket with a drive mechanism to create mechanical interaction between the soiled article and the washing fluid.

19. The method for exchanging removable agitation baskets in a treatment system of claim 18, wherein the washing fluid is a densified fluid.

20. The method for exchanging removable agitation baskets in a treatment system of claim 18, wherein driving includes rotating the removable agitation basket about the longitudinal axis.

21. The method for exchanging removable agitation baskets in a treatment system of claim 14, further comprising removing from the first removable agitation basket a treated article.
